(19) United States
(12) Patent Application Publication
(10) Pub. No.: US 2010/0244482 A1
(43) Pub. Date: Sep. 30, 2010

(54) Tonneau Cover

(76) Inventors: John C. Montagna, Metamora, MI (US); Leslie E. Smith, Corinth, MS (US); Thomas G. Sierakowski, Metamora, MI (US); Vincent B. Rocheleau, Metamora, MI (US); William Matthew McCreedy, Leonard, MI (US)

Correspondence Address: Christopher John Rudy, 209 Huron Avenue Suite 8, Port Huron, MI, 48060, US

(21) Appl. No.: 11/991,818

(22) PCT Filed: Sep. 11, 2006
(86) PCT No.: PCT/US06/35441

§ 371 Date: Mar. 11, 2008

Related U.S. Application Data
(60) Provisional application No. 60/716,270, filed on Sep. 12, 2005.

(51) Int. Cl. B60P 7/02

(52) U.S. Cl. 296/100.02

(57) ABSTRACT

Tonneau cover for mounting to a pickup truck having a cargo bed has a top panel and a bottom panel, wherein the bottom panel includes opposing arrays of upwardly extending projections having flat coplanar upper surfaces with the arrays divided by a beam feature that extends in a front to rear direction of the cover. The beam feature itself may include a series of upwardly extending projections having flat coplanar upper surfaces, which, advantageously, are elongate along the front to rear direction.

This claims priority of US60/716,270 (12 Sep. 2005 A.D.).

### FIELD OF THE INVENTION

The present invention concerns a tonneau cover, which, in particular, is an improvement over a tonneau cover as published in the following patent applications: Pub. No. US 2005/010177 A1 (30 Jun. 2005 A.D.) and WO 2005/065123 A2 (21 Jul. 2005 A.D.), each entitled, “Method of Manufacturing Composite Vehicle Panels.”

### BACKGROUND TO THE INVENTION

When a tonneau cover was made with an array of frusto-conical members across its bottom such as disclosed in the aforementioned international publication, as effective and efficient as it was, it was found to flex somewhat, especially curving from the front to rear when mounted to and lifted up from the bed of a pickup truck. It was desired, however, to have a more rigid tonneau cover, which yet incorporated the significant advantages provided by such art.

### DISCLOSURE OF THE INVENTION

In address of such a difficulty, it has been discovered that, in general, a more rigid tonneau cover comprises a top panel and a bottom panel associated therewith, wherein the bottom panel includes opposing arrays of upwardly extending projections having flat coplanar upper surfaces with the arrays divided by a beam feature that extends in a front to rear direction of the cover. The beam feature itself may include a series of upwardly extending projections having flat coplanar upper surfaces, which, advantageously, are elongate along the front to rear direction.

The invention is a useful tonneau cover for a pickup truck.

Significantly, by the invention, a very rigid tonneau cover is provided, which can be lightweight, durable, and economical. Numerous further advantage attend the invention.

The drawings form part of the specification hereof. With respect to the drawings, which are not necessarily drawn to scale, the following is briefly noted:

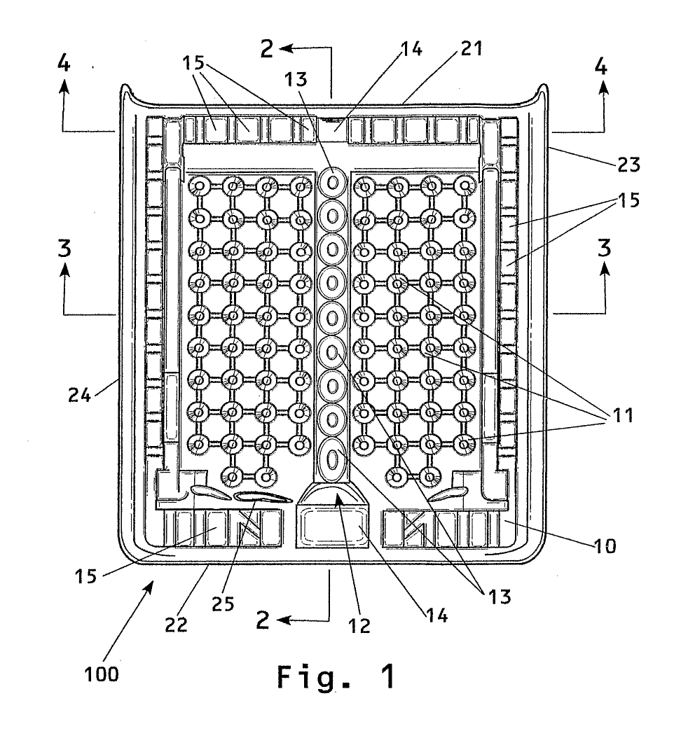

FIG. 1 is a bottom view of a tonneau cover of the invention.

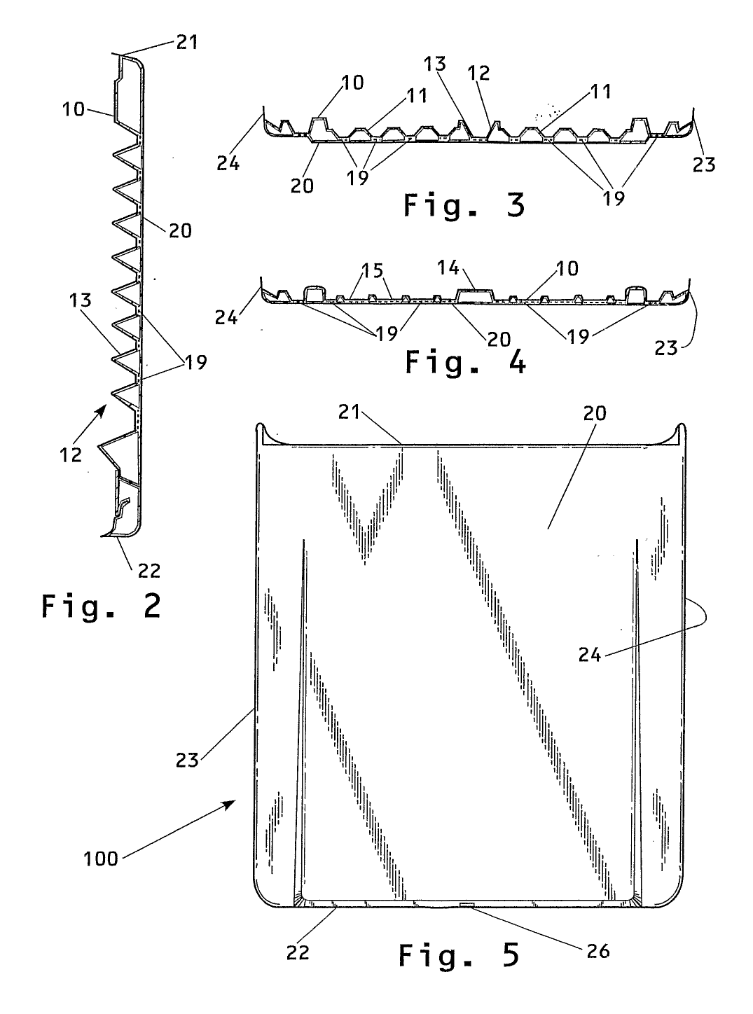

FIGS. 2-4 are cross-sectional views of the cover, taken along section lines 2-2, 3-3 and 4-4, respectively, as found in FIG. 1.

FIG. 5 is a top view of the cover of FIGS. 1-4.

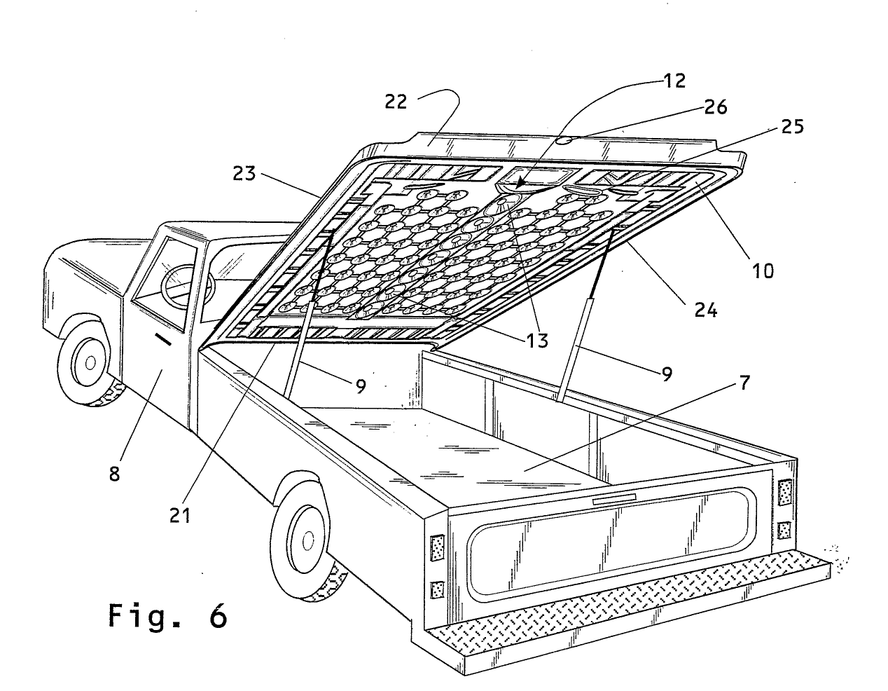

FIG. 6 is a rear view of the cover of FIGS. 1-5, attached to a pickup truck and lifted up from its cargo bed.

The invention can be further understood by the detail below, which may be read in view of the drawings. Such is to be taken in an illustrative and not necessarily limiting sense.

With respect to the drawings, composite tonneau cover 100 is for mounting onto the cargo bed 7 of pickup truck 8, and may be supported in an uplifted position by pneumatic/hydraulic assist bars 9. The cover 100 includes bottom 10 and top 20 panels made of suitable plastic, especially from a thermoformable sheet material, for example, an about two and one-half millimeter thick ABS plastic.

The bottom 10 includes opposing arrays of upwardly extending projections 11 having flat coplanar upper surfaces, which projections 11 advantageously have tapering sides; for example, such projections 11 may define frusto-conical cups with rounded “corners,” say, with diameters about ninety-four millimeters at the open portion and fifteen-degree sides measured from the perpendicular to its top, flat surface; depths about from twenty-five to seventy millimeters, with the shallower cups nearer the sides and front; and about eighteen-millimeter radii by the open, lower portions of the cups, and about twelve-millimeter radii by the top, coplanar upper surfaces. The arrays are divided by beam feature 12 that extends in a front to rear direction of the cover 100. The beam feature 12 can embrace an elongate protrusion, which, for example, extends down some nineteen millimeters, which beneficially includes a series of upwardly extending projections 13 having flat coplanar upper surfaces, which, advantageously, are elongate along the front to rear direction, i.e., have a dimension greater along their lengths from front to rear than along their widths generally orthogonal to their lengths, but otherwise may be generally analogous to the projections 11 with tapering sides; for example, such projections 13 may be thought of as bowls that are elliptical with tapering sides with rounded “corners,” say, which are about nineteen millimeters deeper than cups 11 close by, with the bowls 13 in the front more shallow; have major axes that define a central axis of the beam 12, which are typically about one hundred thirty five millimeters with the bowl 13 near the rear having its length altered to accommodate the length of the cover 100, which typically is provided at lengths about from four and one half to six and one half feet; have minor axes about one hundred and two millimeters; sides that blend from about thirty-three degrees at the ends of the major axes, measured from the perpendicular to its top, flat surface, to about twenty-four degrees at the ends of the minor axes, measured from the perpendicular to its top, flat surface; and about eighteen-millimeter radii by the open, lower portions of the cups, and about twelve-millimeter radii by the top, coplanar upper surfaces. Topographical features 14, which may be protrusions and depend downward and/or be depressions and extend upward, may be provided along the beam feature 12. Lateral topographical features 15, which may be depressions and/or protrusions, may be provided also. Adhesive 19 binds the bottom panel 10 to the top panel 20, and, although the cover 100 is advantageously hollow, it may have a filler provided in otherwise open volume between its bottom 10 and, top 20 panels, for instance, a foamed polyurethane or a glass wool, which may provide additional thermally and/or sonically insulative characteristics. As defined in relation to the truck 8 and the top 20, the front 21, rear 22, left hand side 23, and right hand side 24 are found. Strap 25 may be provided to assist in closing or opening the cover 100 mounted to the truck 8, and lock device 26 may be provided to secure a mounted cover 100 when closed.

The present invention is thus provided. Various feature(s), part(s), subcombination(s) and/or combination(s) can be employed with or without reference to other feature(s), part(s), subcombination(s) and/or combination(s) in the practice of the invention, and numerous adaptations or modifications can be effected within its spirit, the literal claim scope of which is particularly pointed out as follows:

What is claimed is:

1. (canceled)

2. A tonneau cover comprising a top panel and a bottom panel associated therewith, wherein the bottom panel includes opposing arrays of upwardly extending projections having flat coplanar upper surfaces with the arrays divided by a beam feature that extends in a front to rear direction of the tonneau cover, wherein the beam feature includes a series of upwardly extending projections having flat coplanar upper surfaces.

3. The tonneau cover of claim 2, wherein the upwardly extending projections are elongate along the front to rear direction of the beam feature.

4. The tonneau cover of claim 3, wherein the upwardly extending projections of the bottom panel have tapering sides that define frusto-conical cups; the beam feature embraces an elongate protrusion, which includes the series of upwardly extending projections; and the upwardly extending projections have tapering sides, and have major axes that define a central axis of the beam feature.

5. The tonneau cover of claim 4, wherein there are also present topographical features, which include at least one of protrusions that depend downward and depressions that extend upward are provided along the beam feature; and lateral topographical features, which include at least one of depressions and protrusions.

6. (canceled)

7. The tonneau cover of claim 2, wherein adhesive, binds the bottom panel to the top panel.

8. The tonneau cover of claim 3, wherein adhesive binds the bottom panel to the top panel.

9. The tonneau cover of claim 4, wherein adhesive binds the bottom panel to the top panel.

10. The tonneau cover of claim 5, wherein adhesive binds the bottom panel to the top panel.

11. (canceled)

12. The tonneau cover of claim 2, wherein the bottom and top panels are made from a suitable thermoformable plastic.

13. The tonneau cover of claim 3, wherein the bottom and top panels are made from a suitable thermoformable plastic.

14. The tonneau cover of claim 4, wherein the bottom and top panels are made from a suitable thermoformable plastic.

15. The tonneau cover of claim 5, wherein the bottom and top panels are made from a suitable thermoformable plastic.

16. In combination, a tonneau cover comprising a top panel and a bottom panel associated therewith, wherein the bottom panel includes opposing arrays of upwardly extending projections having flat coplanar upper surfaces with the arrays divided by a beam feature that extends in a front to rear direction of the tonneau cover, wherein the beam feature includes a series of upwardly extending projections having flat coplanar upper surfaces; and a pickup truck having a cargo bed, to which the tonneau cover is attached.

17. The combination of claim 16, wherein the series of upwardly extending projections of the beam feature are elongate along the front to rear direction of the beam feature.

18. The combination of claim 17, which includes at least one pneumatic/hydraulic assist bar for supporting the tonneau cover in an uplifted position.

19. The combination of claim 18, wherein the bottom and top panels of the tonneau cover are made from a suitable thermoformable plastic.

20. The combination of claim 19, wherein adhesive binds the bottom and top panels of the tonneau cover.

21. The combination of claim 20, wherein a lock device is provided to secure the tonneau cover when it is closed in relation to the cargo bed of the pickup truck.

22. A tonneau cover comprising a top panel and a bottom panel associated therewith, wherein the top and bottom panels are made of a suitable plastic, and the bottom panel includes opposing arrays of discrete upwardly extending projections, which projections are rounded in overall shape when viewed from a bottom direction and have flat coplanar upper surfaces, with the arrays divided by a beam feature that extends along a single axis in a front to rear direction of the tonneau cover.

23. The tonneau cover of claim 22, wherein adhesive binds the bottom panel to the top panel.
